(19) United States
(12) Patent Application Publication
(10) Pub. No.: US 2007/0123106 A1
(43) Pub. Date: May 31, 2007

(54) CABLE CONNECTOR

(75) Inventor: Zhejia ZHANG, Dongguan (CN)

Correspondence Address: MATTHIAS SCHOLL, 14781 MEMORIAL DRIVE, SUITE 1319, HOUSTON, TX, 77079, US

(73) Assignee: DONGGUAN COMAX ELECTRON LTD., Dongguan (CN)

(21) Appl. No.: 11/550,422

(22) Filed: Oct. 18, 2006

(30) Foreign Application Priority Data
Oct. 29, 2005 (CN) 200510100903.8

(51) Int. Cl. H01R 9/03

(52) U.S. Cl. 439/610

(57) ABSTRACT

A cable connector comprising a connection-peg, comprising a plurality of transmission terminals; a plurality of transmission channels, electrically connecting with transmission terminals and comprising signal wires in pair; a plurality of earthing wires, mounted in the place among the each transmission channels; a first conducting cover unit, binding and laying over one of the section of every transmission channel and earthing wire, wherein one of the area of the transmission channels and earthing wires between the first conducting cover unit and the transmission terminals aren't covered by the first conducting cover unit, and at least a pair of signal wires of one transmission channel worries each other, and a second conducting shelter unit, binding and laying over the uncovered area.

### BACKGROUND OF THE INVENTION

1. Field of the Invention

The present invention relates to a cable connector, and more particularly to a cable connector that transmits the high frequency signal of the low voltage differential signal.

2. Description of the Prior Art

When a cable transmits electric current, because of shooting and acceptance of signals having a different potential, which form a noise voltage, producing interference of electromagnetic from other circuit signals, it influences the quality of the whole circuit, that is what we called EMI, so how to resolve the interference of the electromagnetic has become a topic that we have to face.

Nowadays, because low voltage differential signaling (LVDS) is provided with the superiority of low voltage, producing more stable signal, we usually use it to reduce the EMI of equipments.

Recently, in order to satisfy the increasing frequency of signal transmission, we usually use a sort of flat cable covered by the method of aluminum foil and melt weaver to transmit the signal, thereby producing a earthing return channel of low electromagnetic mutual for signal electric current, reducing the interference of the noise.

Commonly, a flat cable comprises a plurality of sets of transmission signal pairs, which are formed by two transmission signal wires with both sides of stickiness adhesive plaster binding face to face, as disclosed in the Chinese Application No. 094106716, but during the course of manufacture, because of the encounter of each other, the match of the impedance of each signal transmission pair produces an error.

### SUMMARY OF THE INVENTION

The primary object of the present invention is to provide a electric connector with a higher transmission efficiency, a more convenient manufacture method and being of more competitive and reliable comprising. A cable connector comprising a connection-peg, comprising a plurality of transmission terminals; a plurality of transmission channels, electrically connecting with transmission terminals and comprising signal wires in pair; a plurality of earthing wires, mounted in the place among the each transmission channels; first conducting cover unit, binding and laying over one of the section of every transmission channel and earthing wire, wherein one of the area of the transmission channels and earthing wires between the first conducting cover unit and the transmission terminals aren't covered by the first conducting cover unit, and at least a pair of signal wires of one transmission channel worries each other, and a second conducting shelter unit, binding and laying over the uncovered area, a melt housing mounted on the connection-peg and laying over the transmission terminals, a plurality of third conducting shelter units, binding and covering each transmission channel in the first conducting cover unit.

The first conducting cover unit is a conducting adhesive plaster; the second conducting cover unit is formed by oppositely binding of two melt weavers provided with conducting adhesive layers; each signal wire is provided with an outer insulating layer; the second conducting cover unit binds and covers the first conducting cover unit and melt housing of the area.

The third conducting cover units conduct in the single side, and is provided with insulating adhesive layer on the side opposite to the transmission channels.

### BRIEF DESCRIPTION OF THE DRAWINGS

FIG. 1 is an amplified perspective view showing the present invention;

FIG. 2 is a sectional amplified plane view showing the present invention; and

FIG. 3 is a sectional view showing the cable body of the present invention.

### DETAILED DESCRIPTION OF THE PREFERRED EMBODIMENTS

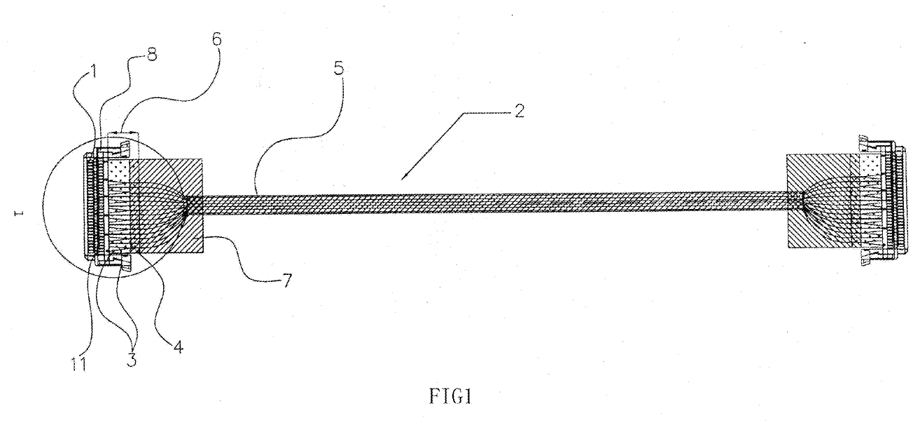

Referring to FIG. 1, the present invention comprises a connection-peg 1 which is provided with a plurality of transmission terminals 11, that is to say wherein the transmission terminals 11 are mounted in the connection-peg separately, thereby electrically connecting with each transmission channel 3 and a cable body 2, and the cable body 2 comprises a plurality of transmission channels, a plurality of earthing wires mounted in the place among the each transmission channel 3, a first conducting cover unit 5 binding and covering each transmission channel 3 and earthing wire 4.

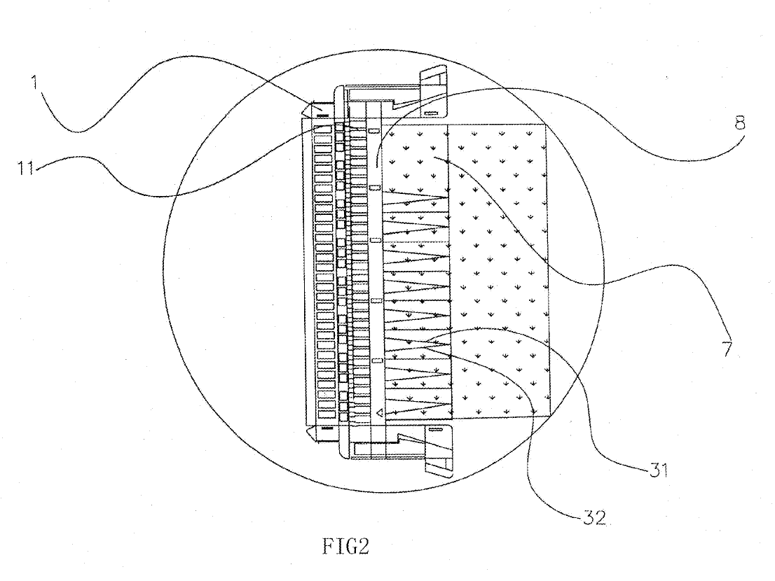

Referring to FIG. 2, each transmission channel comprises a plurality of signal wire pairs 31, 32, providing the return path of the electric current of the circuit equipment connected by signal transmission terminals 11, forming a transmission pair. In order to avoid the errors of impedances among the transmission channels 3 produced by the interference of the encounter of each other during the course of manufacture, the first conducting cover unit 5 doesn't lay over the wires 4 and transmission channels 3, and it is just say that there is one of the section of transmission channels 3 and earthing wires between the first conducting cover unit 5 and transmission terminals 11 isn't covered, so we can cover with this area via the second conducting cover, after fine trimming the impedance among the signal wires of each transmission channel.

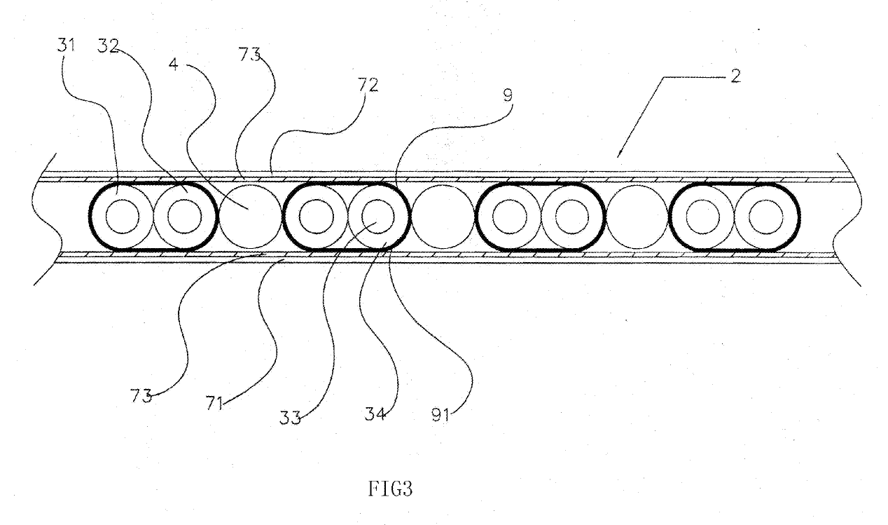

Referring to FIG. 3, each signal wire 31, 32, out of the conducting layer, opposite to the second conducting cover unit 7, has an insulting layer, thereby effectively separating transmission signals and voltage noises. The first conducting cover unit is made of two melt weavers 71, 72, the inner layer of which is provided with conducting adhesive layer, thereby sticking and laying over insulting layer out of each signal wire 31, 32 and earthing wire 4, and the earthing wire is bared, thereby increasing the effect of earthing.

Referring to FIGS. 2 and 3, during the course of manufacture, first of all, make the signal wires 31, 32 of transmission channels 3 and earthing wires 4 adhere to the first conducting cover unit. Then, when the first conducting cover unit 5 adheres to each transmission channel 3 and earthing wire 4, it is leaved an uncovered area 6, making the conducting adhesive layer of melt weaver adhere to the first conducting cover unit 5. Furthermore, wherein a plurality of channels 3 are extended by the first conducting cover unit 5, which stands on the place among signal wire pairs 31, 32 in order and there is at least one signal wire pair of transmission channels 31, 32 is wrapped each other. According to the need of impedance of the signal wire of each transmission channel, fines trimming it to the best one, then make the conducting adhesive layer 73 of another melt weaver 72 and the melt weaver bind and cover the uncovered area 6 of signal wires 31, 32 and earthing wires 4 face to face.

Wherein the conducting layer 33 of signal wire pairs 31, 32 of transmission channels 3 electrically connects with each transmission terminal 11 of the connection-peg in order. A melt housing mounts on the connection-peg and adheres to the uncovered area 6, covering the transmission terminals 11 and the conducting layer 33 of signal wires. Because of the second conducting shelter unit 7 oppositely adhering to the transmission channels 3 and the earthing wires 4 in the area between the first conducting shelter unit 5 and melt housing 8, don't produce interference aroused by trimming among the each transmission channels 3, which ensure each impedance of the transmission channel in the cable body is matched.

Out of the signal wires 31, 32 of each transmission channel 3 among the insulating layer of the first conducting cover unit 5 is the third conducting cover unit (FIG. 9), wherein the third conducting cover unit 9 is an aluminum foil kemel or other melt foil with a single conducting side. Furthermore, there is an insulating adhesive layer 91 on the non-conductive side of the third conducting cover unit 9, thereby adhering and positing the insulating layer 34 of signal wire 31, 32. For example: the insulating layer is made of heating thermoplastic adhesive materials mounted on the non-conductive side of the aluminum foil mylar, forming the aluminum foil provided with adhesive layer, then mounts it in the inner side, tightly constraining the signal wire via making use of the method of spirally wrapping and covering, melting it after that immediately, binding the insulting layers of signal wires and the heating thermoplastic adhesive materials to a wholly one.

It is of course to be understood that the embodiments described herein are merely illustrative of the principles of the invention and that a wide variety of modifications thereto may be effected by persons skilled in the art without departing from the spirit and scope of the invention as set forth in the following claims.

The following is a list of abbreviations used in the text of the specification and in the drawings: 1—connection-peg; 2—cable body; 3—transmission channel; 4—earthing wire; 5—the first conducting cover unit; 6—uncovered area; 7—the second conducting cover unit; 8—melt housing; 9—the third conducting cover unit; 11—transmission terminal; 31, 32—signal wire; 33—conducting layer; 34—insulating layer; 71, 72—melt weavers; 73—conducting adhesive layer; 91—insulating adhesive layer.

What is claimed is:

1. A cable connector comprising
a connection-peg, comprising a plurality of transmission terminals;
a plurality of transmission channels electrically connecting with said transmission terminals and comprising pairs of signal wires;
a plurality of earthing wires mounted between said transmission channels;
a first conducting cover unit enclosing said transmission channels and said earthing wires,
an uncovered area wherein said transmission channels and said earthing wires are partially not covered by cover units; and
a second conducting cover unit disposed between said uncovered area and said first conducting cover unit and enclosing said transmission channels and said earthing wires.

2. The cable connector according to claim 1 wherein said first conducting cover unit is a conducting adhesive plaster.

3. The cable connector according to claim 1 wherein said second conducting cover unit is formed by joining two opposite melt weavers provided with conducting adhesive layers.

4. The cable connector according to claim 1 wherein the cable connector further comprises a melt housing mounted on the connection-peg and enclosing said transmission terminals.

5. The cable connector according to claim 1 wherein each signal wire is provided with an outer insulating layer.

6. The cable connector according to claim 1 wherein the earthing wire is a bare wire.

7. The cable connector according to claim 1 comprising further a melt housing, wherein said second conducting cover unit overlaps with said first conducting cover unit and said melt housing.

8. The cable connector according to claim 1 further comprising a plurality of third conducting cover units, said third conducting cover units binding and covering each transmission channel within said first conducting cover unit.

9. The cable connector according to claim 8 wherein said third conducting cover units conduct on a single side and are provided with an insulating adhesive layer on the side opposite of the transmission channels.

10. The cable connector according to claim 8 wherein said third conducting cover units are made of aluminum foil mylar.
